(19) United States
(12) Patent Application Publication
(10) Pub. No.: US 2006/0119049 A1
(43) Pub. Date: Jun. 8, 2006

(54) Slip-ring seal arrangement

(76) Inventors: Peter Feigl, Hohenrain (DE); Clemens Simon, Starnberg (DE)

Correspondence Address: EDWARDS & ANGELL, LLP, P.O. BOX 55874, BOSTON, MA, 02205, US

(21) Appl. No.: 10/524,914

(22) PCT Filed: Aug. 14, 2003
(86) PCT No.: PCT/EP03/09014

§ 371 Date: Sep. 15, 2005

(30) Foreign Application Priority Data
Aug. 21, 2002 (DE) 202 12 848.2

(51) Int. Cl. F16J 15/34

(52) U.S. Cl. 277/404

(57) ABSTRACT

A mechanical face seal assembly comprises at least a single pair of seal rings (4, 5) whose opposed seal faces (9, 10) are held together in sealing engagement, one of the seal rings is non-rotatable while the other is provided for rotation in common with a rotary component (2). The two seal rings are formed of a SiC material to which a graphite component is added for at least one of the seal rings. The graphite component is provided in particulate form in a proportion of between 1.0 and 4.0 Vol % in a SiC matrix material comprising SiC crystals having a grain size of between 5 and 1500 μm. The grain size of the graphite particles amounts to between 20 and 200 μm.

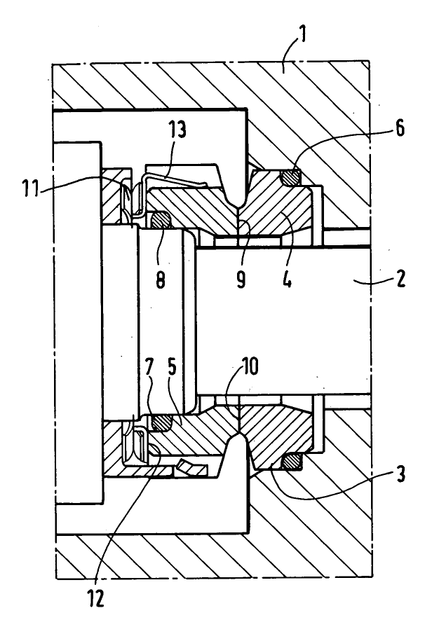

The invention relates to a mechanical face seal assembly in accordance with the preamble of claim 1. It relates, in particular, to a mechanical face seal assembly having self-lubricating properties for use in the sealing of liquid or gaseous media.

A special field of application of a mechanical face seal assembly in accordance with the invention is that of sealing the drive shafts of CO₂ compressors for air conditioning systems of motor vehicles. Here, a basic demand on the mechanical face seal assembly is a long life span with minimum leakage rate under the prevailing operational conditions which are characterized especially by a high pressure of the medium requiring sealing (CO₂—oil mixture). Usually (e.g. EP-A-1 098 117), in the case of seal ring pairs wherein, for reasons of improved abrasion resistance and good thermal conductivity, one of the seal rings consists of a silicon carbide (SiC) material made into the desired form by a sintering process, the other seal ring cooperating therewith is formed of a material having good sliding properties such as graphite in order to produce a self-lubricating effect at the cooperating seal faces of the seal rings. The disadvantage of seal rings made of pure graphite is their low resistance to deformation under the effective forces due to the low modulus of elasticity of graphite so that these seal rings can easily be distorted and deformations may be produced which not only lead to increased leakage but also result in increased wear of the seal faces. It has already been proposed (EP-A-1 205 695), to provide a seal ring pair wherein one seal ring consists of a SiC material and the other of a composite SiC graphite material. In a sintering process, the graphite component is formed in a layer close to the seal face by transforming only partially the graphite phase into SiC. The graphite content of this layer may amount to between 40 and 85%, which means extensive graphitization of the seal face which, in regard to its operational behaviour, does not differ substantially from a pure graphite surface. Furthermore, in the case of a mechanical face seal assembly operating in non-contact making manner (EP-A-0 900 959), it is known to form at least one of the cooperating seal rings from a composite SiC graphite material. Hereby, special demands on the abrasion resistance of the seal rings are not made since the seal faces are held out of contact with one another when in operation due to a medium-filled gap that is formed therebetween by means of pumping structures formed in the seal faces.

An object of the invention is to produce a mechanical face seal assembly of the type mentioned above in which the seal faces of the cooperating seal rings can make sealing engagement with one another during operation, which has improved wear properties and operational behaviour and thus an extended life span and is particularly suitable for use in CO₂ refrigeration compressors for motor vehicle air conditioning systems.

In accordance with the invention, this object is achieved by the features of claim 1. Accordingly at least one of the cooperating seal rings consists of a composite SiC graphite material wherein the graphite component is provided in particulate form having a comparatively low proportion of only between 1.0 and 4.0 Vol % in a SiC base material containing SiC crystals of a certain grain size. By contrast, the other seal ring can be formed of a conventional SiC material. Preferably however, the composite SiC graphite material is used for both seal rings. Because of the high proportion of SiC which is significantly greater than that in the known composite SiC graphite materials, the operational behaviour of the seal ring is practically unimpaired by the graphite component so that the advantageous mechanical and thermal properties of SiC remain essentially unrestricted and a mechanical face seal assembly constructed in accordance with the invention is distinguished by a high abrasion resistance, long life span and good operational stability. The grain size of the graphite particles should amount to between 20 and 200 μm, preferably 40 and 150 μm, and most preferably to between 50 and 120 μm. It has been found that despite the low proportion of graphite an adequate and stable lubricating film is always formed between the cooperating seal faces of the seal rings in order to prevent excessive friction and heating of the seal rings associated therewith. Among other things, this means that the mechanical face seal assembly operates with a very low power consumption. At the same time, the mechanical face seal assembly is characterised by its high leakage resistance. For example, over long periods of operation, it was foundd that there was a practically negligible leakage of oil in the case of a medium requiring sealing in the form of an oil/CO₂ mixture, while the leakage of CO₂ always remained significantly below the permissible limits. In regard to advantageous further embodiments of the invention, reference should be made to the claims.

The invention is explained in more detail hereinafter with the aid of embodiments thereof and the drawing which shows in a longitudinal sectional view a mechanical face seal assembly.

In the drawing, the reference number 1 refers to a housing (fragmentarily shown) of an equipment requiring sealing, e.g. a refrigerant compressor for compressing a refrigerant such as CO₂, and reference number 2 refers to a shaft, e.g. a compressor drive shaft which extends through a bore 3 in the housing. A mechanical face seal assembly is provided for sealing the shaft 2 with respect to the bore 3 of the housing. However, the invention is restricted to neither the aforementioned application to refrigerant compressors nor to a special embodiment of the mechanical face seal assembly which will be explained in more detail hereinafter.

The mechanical face seal assembly comprises a pair of cooperating seal rings 4, 5, of which the seal ring 4 is provided for non-rotatable mounting to the housing 1 and the seal ring 5 for rotation in common with the shaft 2. An O-ring 6 can be disposed in a groove in the outer periphery of the non-rotatable seal ring 4 for sealing the non-rotatable seal ring 4 with respect to the housing bore 3. The seal ring 5 rotating with the shaft 2 may contain an axial recess 7 in the peripheral surface thereof facing the shaft 2, an O-ring 8 being inserted into this recess for providing a sealing effect between the rotary seal ring 5 and the shaft 2. The seal rings 4, 5 have radial seal faces 9, 10 facing each other, which are held in sealing engagement with each other by a biasing means 11 which applies an axial biasing force to the rotary seal ring 5 for urging it against the non-rotatable seal ring 4.

The biasing means 11 may comprise a disc spring or a coiled spring, which is supported at one axial end thereof on a support ring 12 that is fixed to the rotary seal ring 5 by means of a clip 13. The support ring 12 may cover the outer axial end of the recess 7 accommodating the O-ring 8 so that the O-ring 8 is prevented from escaping from the recess 7.

The previously described construction of the mechanical face seal assembly is known in principle from DE-U-201 20 966 so that reference may be made to this publication in regard to further details.

In accordance with the invention, both of the seal rings 4, 5 are formed of a material containing silicon carbide (SiC) as its basis. This material simultaneously has a high inherent rigidity, good abrasion resistance, good heat resistance and a high thermal conductivity. A certain proportion of a graphite component is added to the SiC base material for producing a self-lubricating property or for producing during operation a lubricating film between the mutually engaging seal faces 9, 10.

In accordance with the invention, it has been found that the SiC base material should be composed of plate-like SiC crystals of a certain grain size or should contain at least a certain proportion of such coarse-grained SiC crystals in a fine-grained SiC matrix material. The SiC base material thus possesses a certain suitable porosity, which can amount to about 2 Vol % for example, in order to create pores for accommodating a graphite component. A pore size of between 30 and 150 μm is preferred.

The maximum dimension of the SiC crystals should amount to between 5 and 1500 μm, preferably between 10 and 1000 μm. Suitable techniques for growing such SiC crystals are known to the skilled person and therefore do not need to be explained in detail here.

The proportion of the graphite component in the SiC base material amounts to between 1.0 and 4.0 Vol %, preferably 1.5 and 3.0 Vol %, and most preferably to between 1.8 and 2.5 Vol %. Although the graphite component could be limited to a cross-sectional area near the seal faces 9, 10 whilst the remaining cross-sectional areas of the seal rings 4, 5 could be essentially graphite-free, a uniform distribution of the graphite component over the entire ring cross section is preferred because of the simpler formation of the seal rings 4, 5.

Due to the inclusion of graphite in the pores of the SiC base material, it is present in particulate form without being chemically bound to the SiC of the base material. The size of the graphite particles should amount to between 20 and 200 μm, preferably 40 and 150 μm, and most preferably to between 50 and 120 μm.

The seal faces 9, 10 of the seal rings 4, 5 having the above-mentioned internal structure are finished using known smoothing techniques such as grinding, lapping, to produce a degree of roughness Rₖ within the range of 0.05 to 0.4 μm. Further advantageous ranges for the degree of roughness are: 0.1 to 0.4 μm and 0.15 to 0.3 μm. The most preferable degree of roughness amounts to between 0.2 and 0.25 μm. Reference may be made to the DIN Standard 13565 for a more detailed definition of the degree of roughness Rₖ and the methods for the determination thereof.

Known techniques can be used for the production of seal rings consisting of the above-mentioned composite SiC graphite material. One such technique consists of mixing together SiC grains containing at least a proportion of SiC crystals of the above-mentioned size and graphite particles having the above-mentioned proportion, possibly with the addition of a suitable sintering agent such as boron or aluminium, and then compressing or consolidating the mixture into a shape corresponding to the desired seal ring configuration. The press blank obtained thereby is then heated in a furnace up to a suitably high temperature at which the SiC grains sinter or “bake together” to form a porous microstructure whereby the pores fill with free graphite particles. The size of the pores depends, inter alia, on the size of the SiC crystals used in the granular starting mixture which, as previously mentioned, should amount to between 5 and 1500 μm, and preferably to between 10 and 1000 μm.

### EXAMPLE

A mechanical face seal assembly having a structure such as is shown in the drawing for sealing a shaft having a nominal diameter of 13 mm comprised a pair of seal rings in accordance with the invention consisting of a composite SiC graphite material having the following parameters,:

| | |
|---|---|
| Hardness: | 2500 [HV 0.5] |
| Elastic modulus: | 410 [Gpa] |
| Thermal conductivity: | 110 [W/mK] |
| Coefficient of thermal | <5.5 [10⁻⁶/K] |
| expansion: | |
| Grain size of the SiC | varying between |
| crystals of plate shape: | 10 and 1000 [μm] |
| Proportion of graphite: | 2.2 [Vol %] |
| Particle size of the graphite: | varying between |
| | 50 and 120 [μm] |
| Roughness Rₖ of the seal face: | 0.25 [μm] |

The tests were carried out, in accordance with common practice of application, by using a CO₂/oil mixture as the medium requiring sealing at a temperature of between −40° C. to +200° C., an operating pressure of 4-7 Mpa and a rotational speed of 750 min⁻¹. Over a period of operation of 2000 h, the tests resulted in a minimal leakage of oil of 1 g and of CO₂ of 25 g. This confirms that practically no functional reduction took place over the entire period of operation. When examining the condition of the seal face at the end of the period of operation practically no wear could be found. Both factors are a significant indication in regard to the deformation-free cooperation of the seal rings, which is to due to the high form stability of the composite SiC graphite material being used on the one hand and to the adequate lubricating action thereof on the other. Moreover, only very small losses due to friction between the seal faces were measured. At operating speeds of approximately 2500 min⁻¹, these amounted to only 50% or less than the losses measured for a conventional wear-resistant tungsten carbide/silicon carbide material pairing of the seal rings under otherwise similar operating conditions.

Although the invention has been described above on the basis of an embodiment wherein both seal rings are formed of the composite SiC graphite material in accordance with the invention, this could also be provided—by accepting slightly lowered, but for certain applications readily acceptable operational behaviour—for only one of the seal rings, preferably the rotary seal ring, whilst the non-rotatable seal ring could consist of a conventional SiC material. Furthermore, within the scope of the invention, the graphite material could be replaced by a material having comparable tribological properties subject to that it can be introduced into a SiC base material in the manner explained above.

1. A mechanical face seal assembly comprising at least a single pair of seal rings (4, 5) having opposed seal faces (9, 10) held in sealing engagement with each other, one of said seal rings being non-rotatable and the other for common rotation with a rotary component, both of said seal rings being formed of a SiC material, for at least one of said seal rings a graphite component being added to said SiC material, characterized in that the graphite component is in particulate form in a proportion of between 1.0 and 4.0 Vol %, preferably 1.5 and 3.0 Vol %, and most preferably between 1.8 and 2.5 Vol %, in a SiC matrix material comprising SiC crystals having a grain size of between 5 and 1500 μm, preferably 10 and 1000 μm.

2. The mechanical face seal assembly according to claim 1, characterized in that the grain size of the graphite particles amounts to between 20 and 200 μm, preferably 40 and 150 μm, and most preferably to between 50 and 120 μm.

3. The mechanical face seal assembly according to claim 1, characterized in that the seal faces (9, 10) of the seal rings (4, 5) are worked to provide a degree of roughness Rₖ of between 0.05 and 0.4 μm, preferably 0.1 and 0.4 μm, more preferably 0.15 and 0.3 μm and most preferably of 0.25 μm.

4. The mechanical face seal assembly according to claim 1, characterized in that both seal rings (4, 5) are formed in a same manner.

5. The mechanical face seal assembly according to claim 1, characterized in that only one of the seal rings (4, 5) comprises the graphite component.

6. The mechanical face seal assembly according to claim 1, characterized in that the SiC crystals are provided in an essentially plate-like form.

7. The mechanical face seal assembly according to claim 1, wherein the graphite component is distributed essentially uniformly in the SiC material.
